(19) United States
(12) Patent Application Publication
(10) Pub. No.: US 2018/0302497 A1
(43) Pub. Date: Oct. 18, 2018

(54) METHOD AND SYSTEM FOR AUTOMATING NETWORK MIGRATION

(71) Applicant: ZTE (USA) Inc., Richardson, TX (US)

(72) Inventor: BHUMIP KHASNABISH, Lexington, MA (US)

(73) Assignee: ZTE (USA) Inc., Richardson, TX (US)

(21) Appl. No.: 15/769,097

(22) PCT Filed: Oct. 13, 2016
(86) PCT No.: PCT/US2016/056907

§ 371 Date: Apr. 18, 2018

Related U.S. Application Data
(60) Provisional application No. 62/243,202, filed on Oct. 19, 2015.

(51) Int. Cl. H04L 29/08; H04L 12/24; H04L 12/911; G06F 9/455

(52) U.S. Cl. CPC H04L 67/34; H04L 67/32; H04L 41/0813; G06F 2009/4557; H04L 47/822; G06F 9/45558; H04L 41/12

(57) ABSTRACT

Methods and a system for migrating a network segment from one technology and/or admin domain to another may involve migrating software, hardware, and the management system from one administrative domain and/or paradigm to another. It is possible to achieve both real-time migration and soft-migration (e.g., by using transition gateway) of a network segment beginning from a set of logical and physical ports (including topology) to service specific flow level migration.

### TECHNICAL FIELD

The present disclosure is related generally to computer networking and, more particularly, to methods and a system for automating network migration.

### BACKGROUND

Traditional methods and mechanisms for migrating network segments, entities, and elements from one technology and administrative domain to another focus on physical resources (ports, nodes, links, etc.) and use semi-automated processes. These processes are mostly manual, complex, prone to errors, time consuming, and expensive.

### SUMMARY

In various embodiments, a method for migrating a network segment from a first technology or first administrative domain to a second technology or second administrative domain includes transmitting a request for available network resources and configurations of the second technology or on the second administrative domain, receiving, in response to the request, a list of available network resources of the second technology or second administrative domain and transmitting a request for scheduling and activation of one or more of the listed available network resources of the second technology or second administrative domain. In some embodiments, the method further includes receiving, via the network segment of the first technology or first administrative domain, instructions usable to migrate to the second technology or second administrative domain, and using the received instructions to begin operating with the second technology or on the second administrative domain.

In an embodiment, a method for migrating a network segment from a first technology or first administrative domain to a second technology or second administrative domain includes inventorying existing networking and service entities of the network segment on the first technology or first administrative domain, extracting the configurations of the existing networking and service entities, determining equivalent networking and service entities of the second technology or second administrative domain, and scheduling the migration to the determined equivalent networking and service entities. In some embodiments, the method further includes developing a configuration for each of the determined equivalent networking and service entities, testing the determined equivalent networking and service entities, reconciling the determined equivalent networking and service entities, and finalizing the determined equivalent networking and service entities. In some embodiments, the method further includes scheduling the migration at a time, and performing the migration at the scheduled time. In some embodiments, the method further includes, during a migration period, testing the performance of the network segment on the second technology or second administrative domain and, at the end of the migration period, retiring or releasing the networking and service entities of the first technology or on the first administrative domain.

In an embodiment, a system for migrating a network segment from a first administrative domain to a second administrative domain includes a control domain entity that carries out actions comprising receiving a request from a migration-as-a-service (“MaaS”) application for the migration of the network segment, transmitting, to the MaaS application, a list of networking and service entities in the second administrative domain, wherein the list includes the configurations for capacities and connection patterns of the networking and service entities, and commissioning the physical and virtual resources corresponding to the networking and service entities of the list needed to carry out the requested migration.

In some embodiments, the control domain entity carries out further actions, including reconciling the networking and service entities by using additional mechanisms to handle irreconcilable networking and service entities, receiving, from the MasS application, an acceptance of the list of networking and service entities, releasing the resources of the first administrative domain, and sanitizing the released resources and returning the released resources to a pool of healthy resources.

### DRAWINGS

While the appended claims set forth the features of the present techniques with particularity, these techniques, together with their objects and advantages, may be best understood from the following detailed description taken in conjunction with the accompanying drawings of which:

FIG. 1 is a block diagram of an example networking environment according to an embodiment of the disclosure;

FIG. 2 is a block diagram of a computing device according to an embodiment;

FIG. 3 shows a high-level software defined networking based architecture for apps-/service-triggered automated network migration according to an embodiment;

FIG. 4 depicts the work flow for apps-/service-triggered automated network migration according to an embodiment;

FIG. 5 shows the lifecycle management of physical/virtual resources according to an embodiment;

FIG. 6 is a process flow diagram depicting a method according to an embodiment; and

FIG. 7 is a process flow diagram depicting a method according to another embodiment.

### DESCRIPTION

According to various embodiments, methods and a system for migrating a network segment from one technology and/or administration domain to another is disclosed. In an embodiment, the method may involve migrating a management system from one administrative domain and/or paradigm to another as well. The various techniques described herein may be used in both real-time migration and in soft migration.

According to an embodiment, the techniques described herein achieve real-time migration or soft-migration (by using transition gateway) of a network segment beginning from one set of logical and physical ports to service-specific and flow-level migration.

In an embodiment, a network segment may include a combination of all types of ports, links, LANs, flows, paths, links, hosts and nodes. There may be subnets where each subnet may contain multiple physical and virtual links. The ports, links, LANs, flows, paths, links, hosts and nodes may be physical or virtual or a combination of both.

In an embodiment, the ports may be identified via both physical and logical identifiers. The physical identifiers may include MAC address, Device Identifier, physical location and address, GPS Identifier, etc. The logical identifiers may include IP (v4 or v6 or both) address, subnet Identifier, network Identifier, domain name, autonomous system (AS) name/Identifier, etc.

In an embodiment, a switch can be logical or physical or a combination of both.

In an embodiment, a server (to provide value-added service) can be logical or physical or a combination of both.

In an embodiment, a network attached storage device can be logical or physical or a combination of both.

In an embodiment, the links and paths can be logical or physical or a combination of both.

In an embodiment, a topology can be logical or physical or a combination of both.

The various embodiments described herein may be employed in a variety of scenarios, including real-time migration and soft migration. In case of real-time migration, all types of ports, links, LANs, flows, paths, links, hosts and nodes may need to be migrated from one domain to another in real-time without any service interruption. The management of the network and service entities in the target (destination) domain is carried out via new operations support systems. For automated migration, it may be desirable to streamline and mechanize the entire process of identifying the entities and elements that need to me migrated, develop configurations of these entities and elements, and perform the migration without interrupting any service.

In case of soft migration, a transition gateway (which may be implemented as software executing on the same device as other software components or as a standalone module executed by a computing device) may be required. During the transition in a soft migration, both new and old management and configuration support systems may need to stay operative. The transition gateway that is utilized for migration can host the configurations of both existing and target entities (e.g., a first technology or administrative domain and a second technology or administrative domain) and elements of the network segments. The process of automation can be used to schedule migration in both one step and multiple steps based on the service and loading distribution needs.

In an embodiment, in order to achieve seamless—that is without any form of service interruption—migration, it is required to (a) configure of the equivalent networking and service entities in the target domain, and (b) migrate the service to these newly configured. networking and service entities. This migration and transfer should happen without any service interruption. After the migration, it may be required to monitor the services, performance, security, etc. of the newly configured entities.

According to various embodiments, the method involves the following overall actions:

(1) Collection of the migration requirements from, for example, simple use eases involving migration of elements like devices, links, service, topology network segments and/or domains, and so on.

(2) Development of the migrations steps and automation options, which may involve interactions with one or more elements in the following planes and domains:

Management and Orchestration

Software Defined Network (or Networking) (“SDN”) Controller

Migration/Automation Gateway

Apps-/Service-Plane function (e.g., Migration-as-a-Service or MaaS App.)

Others

(3) Automation of pre-migration. This phase may also be referred to as “automation of pre-migration staving.” Automation of pre-migration involves automatically harvesting resources (port, link, switch, LAN, server, etc.) from the newly deployed infrastructure, allocating the newly harvested resources for the target network segment, and developing configurations for the assigned (newly harvested) resources with an objective to satisfy or exceed the requirements of the services that used-to-be offered using the existing network segment. Put another way, this phase covers automation of staging including resources identification, their configuration and allocation/assignment for services that are offered by the network segment.

(4) Automation of migration. In an embodiment, this involves developing a turn-key solution and scheduling the routing of traffic including any session or transaction request to the newly configured infrastructure. The turn-key solution needs to be pre-tested for proper support of the services, and must have the resources to carry the configuration to support the services that used-to run over the network existing segment (infrastructure). If the equivalent configurations and resources are note supported in the newly migrated segment, proper reconciliation must be achieved prior to migration via appropriate handlers.

In another embodiment, automation of the actual migration event includes scheduling a turn-key event in the managements and operation support system of the existing and target network segment so that live traffic and transaction/session request can he directly dispatched to the target (new) infrastructure. This involves activating the networking segment in the new infrastructure so that the redirected traffic can be served by the newly deployed infrastructure (network segment) without any performance, security, etc., penalty. Once the traffic and session/transaction request migration is complete, the old (existing) network infrastructure (segment) can be decommissioned or maintained as standby or for handling overload from any operational network segment.

(5) Automation of post-migration. This phase may also be referred to as “automation of post-migration management.” In an embodiment, this involves monitoring of the resources for stress, performance, security, etc. in the target domain, cleansing and releasing of the resources in the existing domain, and finally decommissioning of the resources in the existing domain unless the resources in the existing domain are planned for use in case of failure of overload scenarios.

In another embodiment, automation of post-migration involves monitoring and management of (a) services, (b) network devices, and (c) network links including all of the newly assigned resources. The post-migration automation may also include automatic cleansing and releasing of the previously used resources for the same services.

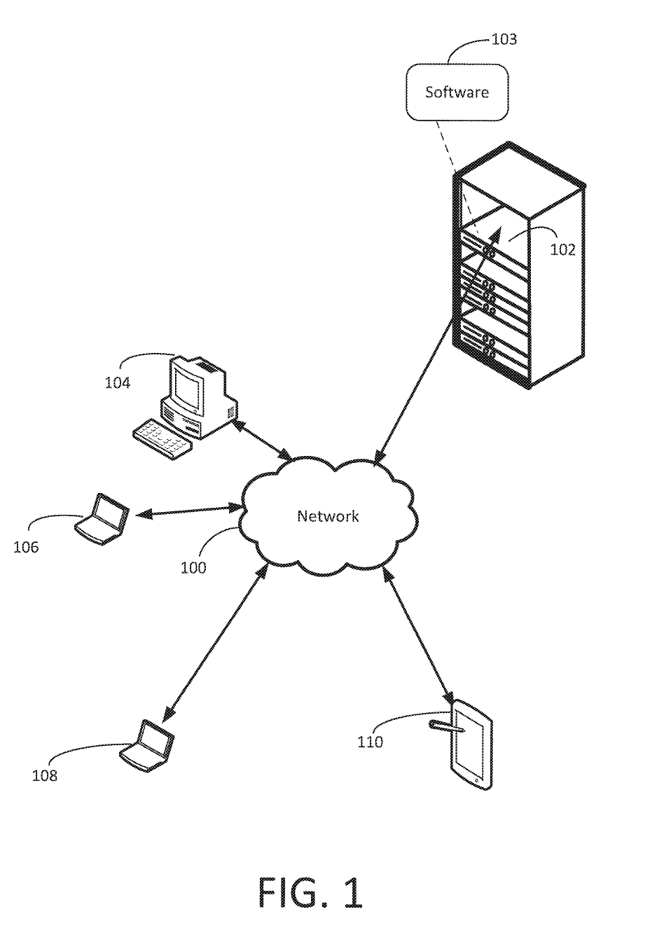

Various embodiments of the disclosure are implemented in a computer networking environment. Turning to FIG. 1, an example of such an environment is shown. A computer network 100 (“network 100”) provides data connectivity to and among multiple computing devices. Possible implementations of the network 100 include a local-area network, a wide-area network, a private network, a public network (e.g., the Internet), or any combination of these. The network 100 may include both wired and wireless components. A first computing device 102 (“computing device 102”), a second computing device 104 (“computing device 104”), a third computing device 106 (“computing device 106”), a fourth computing device 108 (“computing device 108”), and a fifth computing device 110 (“computing device 110”) are each communicatively linked to the network 102.

The computing device 102 executes software 103 (e.g., a set of computer-readable instructions stored in a non-transitory computer-readable medium (e.g., memory)). The computing device 102 is depicted as a rack-mounted server, the second computing device 104 is depicted as a desktop computer, the computing devices 106 and 108 are depicted as notebook computers, and the computing device 110 is depicted as a tablet computer. However, the computing devices depicted in FIG. 1 are merely representative. Other possible implementations of a computing device include a smartphone.

In an embodiment, under the control of the software 103, the first computing device 102 interacts with one or more of the computing devices 104, 106, 108, and 110 to migrate a network segment from one technology or administrative domain to another technology or administrative domain.

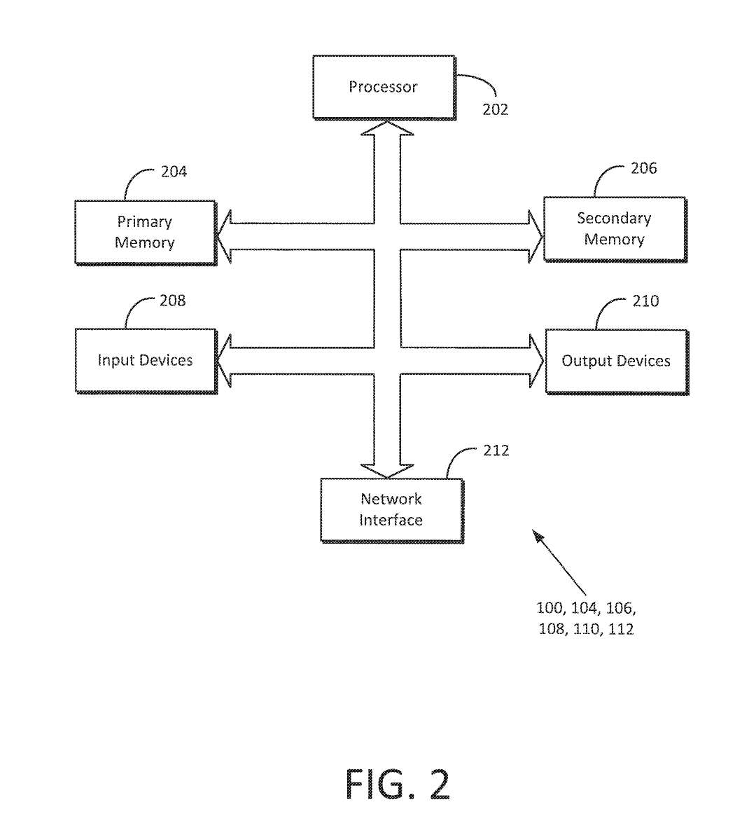

In an embodiment, one or more of the computing devices of FIG. 1 (and any other computing device discussed herein) may have the general architecture shown in FIG. 2. The device depicted in FIG. 2 includes a hardware processor 202 (“processor 202”) (e.g., a microprocessor, a microcontroller, a set of peripheral integrated circuit elements, an integrated circuit (e.g., an application-specific integrated circuit), hardware/electronic logic circuits (e.g., a discrete element circuit), a programmable logic device (e.g., a programmable logic array), or a field programmable gate-array), a primary memory 204 (e.g., volatile memory, random-access memory), a secondary memory 206 (e.g., non-volatile memory), input devices 208 (e.g., user input devices such as a keyboard, mouse, or touchscreen), output devices 210 (e.g., a display, such as an organic, light-emitting diode display), and a network interface 212 (which may be wired or wireless). The memories 204 and 206 store instructions and data. The processor 202 executes the instructions and uses the data to carry out various procedures including, in some embodiments, the methods described herein.

Possible implementations of either or both the primary memory 204 and the secondary memory 206 include volatile memory, non-volatile memory, electrical, magnetic optical memory, random access memory (“RAM”), cache, and hard disc.

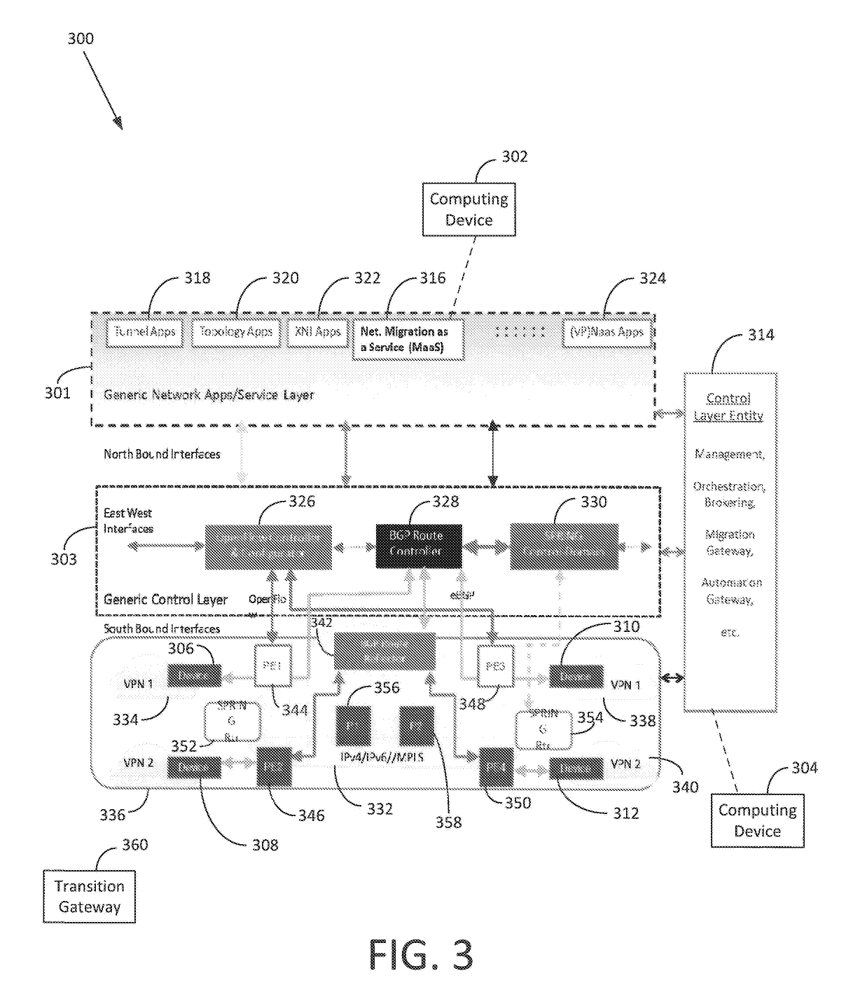

Turning to FIG. 3, a system 300 is shown. The system 300 includes a generic network apps/service layer 301 and a generic control layer 303. The system 300 further includes one or more computing devices, represented by a first computing device 302 (“computing device 302”), a second computing device 304 (“computing device 304”), and other computing devices 306, 308, 310, and 312. The system 300 also includes several software modules (e.g., executable code), including a control layer entity 314, a migration-as-a-service (“MaaS”) module 316, tunnel apps 318, topology apps 320, Any to Network Interface (“XNI”) apps 322, and Networking as a Service (“NaaS”) Apps 324. The system 300 further includes other software modules, including an OpenFlow (as set forth by the Open Networking Foundation) controller and configurator module 326, a Border Gateway Protocol (“BGP”) route controller 328, a Source Packet Routing in Networking (“SPRING”) control-domain module 330, and a BGP route reflector 342.

The system 300 also includes one or more networks, represented by a first network 332 (“network 332”) (examples of which include an IPv4 network, and IPv6 network, and an MPLS network) and virtual private networks 334, 336, 338, and 340. The system 300 also includes Provider Edges (“PE”) 344, 346, 348, and 350 (shown in FIG. 3 as PE1, PE2, PE3, and PE4), SPRING routers 352 and 354, and Provider Edges 356 and 358 (shown in FIG. 3 as P1 and P2). It should be understood that the configuration of the system 300 in FIG. 3 is meant only to be exemplary and that, in some embodiments, the system 300 may have a different set of software and hardware components. It should also be understood that each of the software modules may be implemented as one or more pieces of hardware, such as one or more microprocessors, one or more microcontrollers, one or more application specific integrated circuits, or one or more field programmable gate arrays.

In order to illustrate various embodiments of the disclosure, assume that the computing device 302 executes the MaaS module 316 and that the computing device 304 executes the control layer entity (e.g., software) 314. Thus, when the present disclosure refers to the control layer entity 314 carrying out an action, it may be understood that a computing device, such as the computing device 314, is actually carrying out the action. In some embodiments, the actions that are referred to herein as being carried out by the control layer entity 314 are actually carried out by multiple computing devices. In other words, the functionality of the control layer entity 314 may be distributed among several different pieces of software and/or hardware. The control layer entity 314 (and the computing device on which it executes) may function as one or more of a management and orchestration server, a broker, a configuration server, controller, gateway, etc.

Using the architecture shown in FIG. 3 as an example, a method and system for migrating network segments includes hosted software based automatic update and activation of configuration of one or more physical and virtual network entities (functions), one or more flow-tables, and one or more virtual-machines (service entities) based on application and services requirements. In an embodiment, the system 100 achieves automation of network/service migration to Open-Flow based network segments and service chains. The software can be hosted in one or more software modules, including one or more of “Management & Orchestration,” “SDN Controller,” or a gateway “Platform.”

According to various embodiments, a method and system for migrating network segments allows networking and service elements to be quickly repositioned and reconfigured (by the software) in order to satisfy the demand from the applications and services.

According to various embodiments, a method and system for migrating network segments includes one or more of the following features: (1) the use of an SDN-based architecture that allows separation of Apps, Control, Virtualization, and forwarding domains, (2) the use of both physical and virtualized networking and other resources can be procured and configured, (3) centralized, e.g., hosted in the Controller layer of the SDN architecture, assignment (allocation) and management of the network resources, and (4) basic lifecycle management of physical/virtual networking and service resources with an objective to prevent leaking of residual information because of rapid reassignment of the resources (links and tunnels, routers, switches, ports, server, Apps, services, etc.) to different network/service owners.

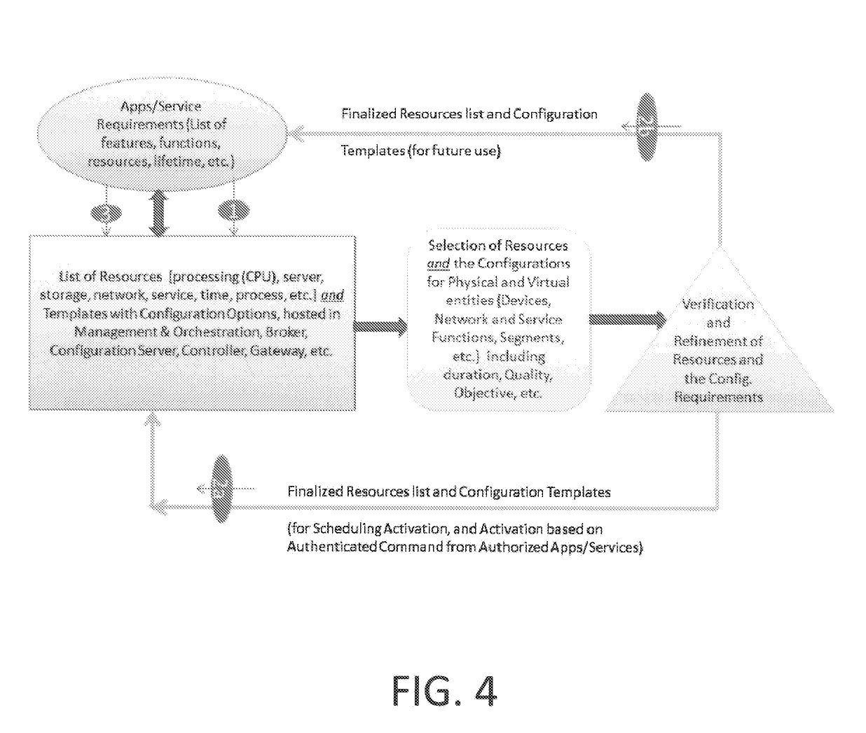

Turning to FIG. 4, an example of a process that may be carried out within the system 300 will now be described. In this embodiment, the MaaS 316 will be referred to as “the requesting application 316.” The requesting application 316 sends a request for resources and configurations (arrow 1) to the control layer entity 314. In response to the request, the control layer entity 314 obtains the list of resources and configurations (arrow 2a) and provides the list to the requesting application 316 (arrow 2b). The requesting application 316 sends a request for scheduling and activation of resources and configurations (arrow 3).

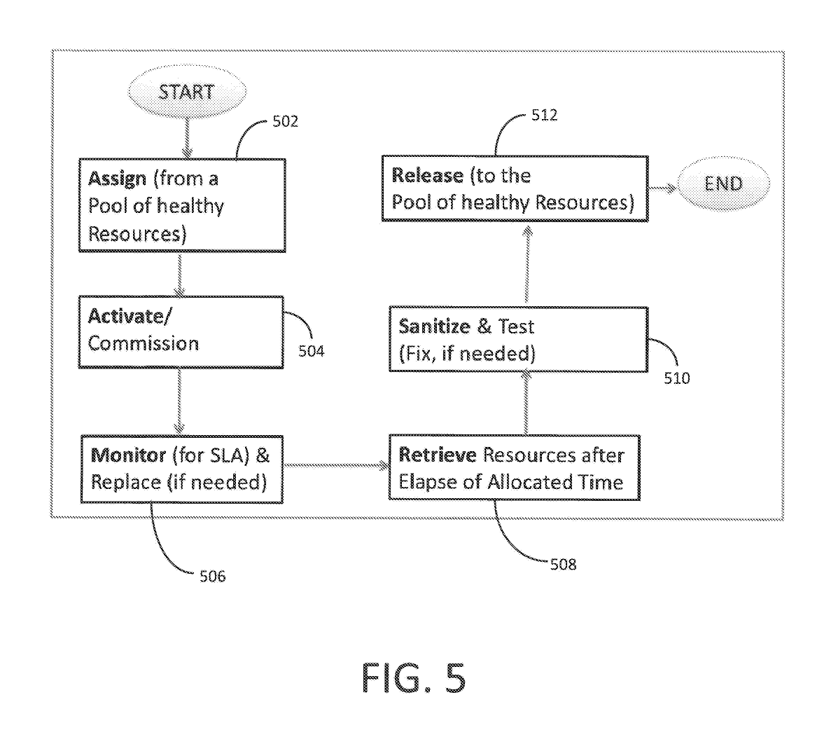

Turning to FIG. 5, another example of a process that may be carried out within the system 300 is depicted. At block 502, physical and/or virtual resources on the target technology or administrative domain are assigned from a pool of healthy resources. At block 504, the resources are activated/commissioned. At block 506, the resources are monitored (for Service Level Agreement (“SLA”)) and replaced, if needed. At block 508, the resources of the former technology or administrative domain are retrieved after the lapse of an allocated period of time. At block 510, the resources of the former technology or administrative domain are sanitized and tested (and fixed, if needed). At block 512, the resources of the former technology or administrative domain are released (to the pool of healthy resources).

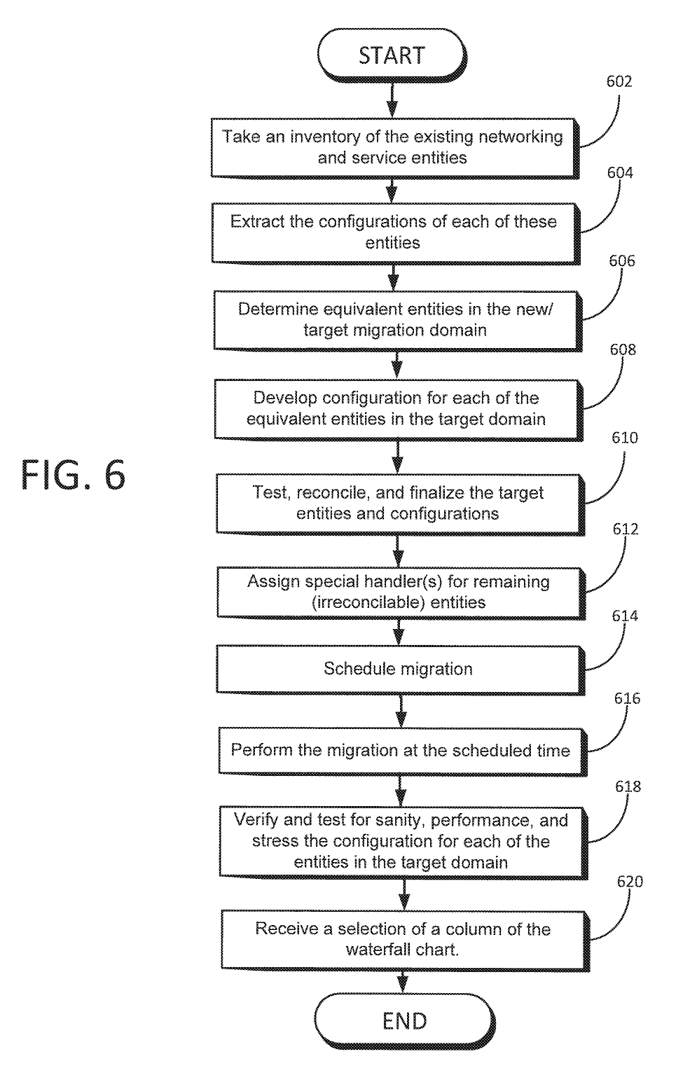

Turning to FIG. 6, another example of a process that may be carried out within the system 300 will now be described. At block 602, the computing device 304 (under control of the control layer entity 314) takes an inventory of the existing networking and service entities. At block 604, the computing device 304 extracts the configurations of each of these entities. At block 606, the computing device 304 determines equivalent entities in the new/target migration domain. At block 608, the computing device 304 develops configuration for each of the equivalent entities in the target domain. At block 610, the computing device 304 tests, reconciles, and finalizes the target entities and configurations. At block 612, the computing device 304 assigns special handier(s) for remaining (irreconcilable) entities. At block 614, the computing device 102 schedules the migration. At block 616, the computing device 304 performs the migration at the scheduled time, backing up and holding the entities in the source (original) domain until these are retired or released. At block 618, the computing device 304, verifies and tests for sanity, performance, and stress (to the system and network) the configuration for each of the entities in the target domain. At block 620, the computing device 304 commits and monitors the network and all of the entities over time for performance, security, and stress.

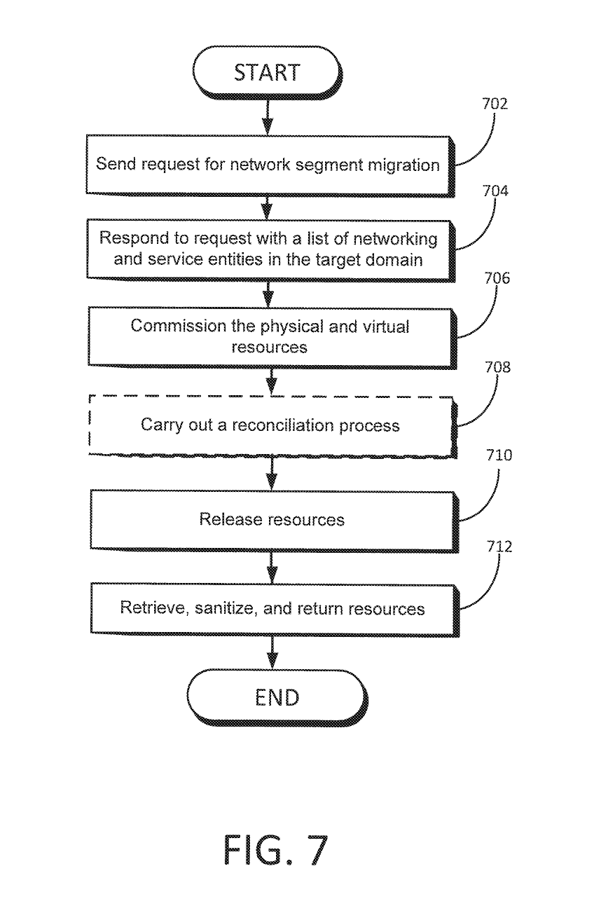

Turning to FIG. 7, another example of a process that may be carried out within the system 300 will now be described. It is to be understood that, although the MaaS 316 will be described as carrying out many of the actions, any authorized MaaS (though not necessarily depicted in FIG. 3) could possibly carry out such actions. At block 702, the MaaS 316 (e.g., the computing device 302 executing the MaaS 316), sends-to the control layer entity 314 (e.g., the computing device 304 executing the control layer entity 314)—a request for network segment migration (“NSM”) setup from one administrative and/or technology domain, identified by a parameter, to another domain. This parameter could be a physical or logical or both identifiers. The physical identifiers may include MAC address, Device Identifier, physical location and address, GPS Identifier, etc. The logical identifiers may include IP (v4 or v6 or both) address, subnet identifier, network Identifier, domain name, autonomous system (AS) name/identifier, etc.

The control layer entity 314 logically controls and manages NSM by switching and connecting (by creating equivalent topology) physical/virtual ports/links/services/etc. At block 704, the control layer entity 314 responds to the request after appropriate authentication with a list of networking and service entities in the target domain, including their configurations for capacities and connection patterns.

Once the control layer entity 314 accepts the list of networking and service entities in the target domain, including their configurations for capacities and connection pattern, the process moves to block 706 at which the control layer entity 314 commissions the physical and virtual resources (ports, link, switches, routers, servers, process, etc.) via an open interface for assigning and activating the resources for the target network segment. In some architectures, e,g., the European Telecommunications Standards Institute (“ETSI”)/Industy Specifications Group (“ISG”) Network Functions Virtualization (“NFV”) Architecture as shown in FIG. 4 of the NFV; Architectural Framework (GS NFV 002) (incorporated herein by reference), the Management and Orchestration domain entities may handle the Requests for Assign/Activate/Retrieve/Release of virtual resources for tunnel setup/release.

Optionally, at block 708, if the control layer entity 314 determines that the resources to be commissioned are not all available, it carries out a reconciliation process regarding the networking and service entities and their configurations. It is to be understood that this reconciliation process may be carried out by other entities besides the control layer entity 314 (e.g., by adding more agile virtual resources). Once the control layer entity 314 no longer needs the resources for any service, the resources are released at block 710. For example, the control layer entity 314 may transmit a request to the various owners of the resources to have the resources released. At block 712, the system 300 retrieves the released resources, then sanitizes and returns the resources to the pool of healthy resources for use by other NSM and services.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art. The terminology used herein is for the purpose of describing the particular embodiments and is not intended to be limiting of exemplary embodiments.

A “computing device” as described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e,g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

The various embodiments may be described herein in terms of functional block components and various processing steps. Such functional blocks may be realized by any number of hardware and/or software components configured to perform the specified functions. For example, the embodiments described herein may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements, one or more embodiments may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, various embodiments may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Words such as “mechanism,” “element,” “unit,” “structure,” “means,” and “construction” are used broadly and are not limited to mechanical or physical embodiments, but may include software routines in conjunction with processors, etc.

The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure.

No item or component is essential to the practice of the various embodiments. It will also be recognized that the terms “comprises,” “comprising,” “includes,” “including,” “has,” and “having,” as used herein, are specifically intended to be read as open-ended terms of art. The use of the terms “a” and “an” and “the” and similar referents are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

We claim:

1. A method for migrating a network segment from a first technology or first administrative domain to a second technology or second administrative domain, the method comprising:
transmitting a request for available network resources and configurations of the second technology or on the second administrative domain;
receiving, in response to the request, a list of available network resources of the second technology or second administrative domain; and
transmitting a request for scheduling and activation of one or more of the listed available network resources of the second technology or second administrative domain.

2. The method of claim 1, wherein network segment comprises one or more ports, links, local area networks, flows, paths, hosts, and nodes.

3. The method of claim 1, further comprising:
receiving, via the network segment of the first technology or first administrative domain, instructions usable to migrate to the second technology or second administrative domain; and
using the received instructions to begin operating with the second technology or on the second administrative domain.

4. The method of claim 1, wherein the transmitting and receiving steps are carried out by a computing device that is to be migrated to the second technology or second administrative domain.

5. The method of claim 1, wherein the transmitting and receiving steps are carried out by a computing device that manages the migration process.

6. A method for migrating a network segment from a first technology or first administrative domain to a second technology or second administrative domain, the method comprising:
inventorying existing networking and service entities of the network segment on the first technology or first administrative domain,
extracting the configurations of the existing networking and service entities;
determining equivalent networking and service entities of the second technology or second administrative domain; and
scheduling the migration to the determined equivalent networking and service entities.

7. The method of claim 6, further comprising:
developing a configuration for each of the determined equivalent networking and service entities;
testing the determined equivalent networking and service entities; reconciling the determined equivalent networking and service entities; and finalizing the determined equivalent networking and service entities.

8. The method of claim 7, further comprising assigning a special handler for the irreconcilable determined equivalent networking and service entities.

9. The method of claim 6, further comprising:
scheduling the migration at a time; and performing the migration at the scheduled time.

10. The method of claim 9, further comprising:
during a migration period, testing the performance of the network segment on the second technology or second administrative domain; and
at the end of the migration period, retiring or releasing the networking and service entities of the first technology or on the first administrative domain.

11. A system for migrating a network segment from a first administrative domain to a second administrative domain, the system comprising:
a control domain entity that carries out actions comprising
receiving a request from a migration-as-a-service (MasS) application for the migration of the network segment;
transmitting, to the MaaS application, a list of networking and service entities in the second administrative domain, wherein the list includes the configurations for capacities and connection patterns of the networking and service entities; and
commissioning the physical and virtual resources corresponding to the networking and service entities of the list needed to carry out the requested migration.

12. The system of claim 11, wherein the control domain entity catTies out further actions comprising reconciling the networking and service entities, including using additional mechanisms to handle irreconcilable networking and service entities.

13. The system of claim 11, wherein the control domain entity carries out further actions comprising receiving, from the MasS application, an acceptance of the list of networking and service entities.

14. The system of claim 11, wherein the control domain entity carries out further actions comprising releasing the resources of the first administrative domain.

15. The system of claim 14, wherein the control domain entity carries out further actions comprising sanitizing the released resources and returning the released resources to a pool of healthy resources.
